(19) United States
(12) Patent Application Publication
(10) Pub. No.: US 2006/0232592 A1
(43) Pub. Date: Oct. 19, 2006

(54) Method of Internet surfing to eliminate the risk of receiving malicious code

(76) Inventor: Paul Leo Faso, Palm Beach Gardens, FL (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/108,553

(22) Filed: Apr. 18, 2005

(51) Int. Cl. G06T 1/60

(52) U.S. Cl. 345/530

(57) ABSTRACT

A method of surfing the Internet or receiving email, utilizing a conversion device having transient memory isolated from other parts of the computer to download digital data from a web page or email client and convert the digital data into an analog display signal for display on a television or computer monitor adapted to display analog display signals, said method preventing unwanted or malicious digital data or code from compromising other components of the computer by isolating the digital data in the transient memory of the conversion device and clearing it from the transient memory of the conversion device when no longer needed.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This invention relates to a secure method of surfing the Internet and, more particularly, to a method of surfing the Internet without exposing the user's computer to unwanted programs such as viruses, worms, cookies, Trojan horses, spyware, adware, surreptitious tracking programs and other malicious programs which can be inadvertently downloaded to a user's computer while surfing the Internet or reading email.

### BACKGROUND OF THE INVENTION

The structure and functioning of the global computer network known as the Internet is well known. Web sites and web pages may be made up of a wide variety of resources of varying protocols which are well known in the art, such as Hypertext Markup Language (HTML) documents, Extensible Markup Language (XML) documents, File Transfer Protocol (FTP), Extensible Hypertext Markup Language (XHTML) documents, and the like. A web site comprising one or more HTML (or FTP, etc.) documents and associated files, scripts, and databases is served up by an HTTP (or FTP, etc.) server connected to the network. Users need a web browser application and a network connection to access a web site, or, more accurately, access the server hosting the particular web page in order to download the resources making up the web site to the user's computer.

Using a web browser application on their computer, a user accesses a particular web site by directing the browser to the web address of the web site or other desired Internet resource. Web addresses, also known by the generic acronym URIs (for Uniform Resource Identifiers) and, less generically, URLs (for Uniform Resource Locators), are used by web browser programs to locate Internet resources, such as files, web sites or individual web pages. The browser application locates the web address and downloads the resources hosted by the server in the form of packets of digital data, storing them in the computer's memory before interpreting the digital data into the words, graphics, programs and other content comprising the elements of the website that are viewed by the user on the computer's monitor. The memory utilized by the browser application may be either transient electronic memory or a permanent memory device such as a hard drive or other digital data storage devices.

Unfortunately, some web addresses contain different types of malicious code or data which may execute upon downloading into the computer's memory and permanently load themselves into the computer in a variety of different ways well known in the art. The vast majority of these methods involve the malicious code writing at least some portion of itself to some portion of the permanent memory storage of the user's computer.

Similarly, when reading email received from other computer users over the network, the emails may have malicious code that executes or hides itself on the user's computer.

Accordingly, there exists a need for a method of surfing the Internet or receiving and reading email without exposing the user's computer to malicious code or data that may be downloaded from the web addresses accessed.

### SUMMARY OF THE INVENTION

The present invention is a novel method of surfing the Internet, i.e., accessing and downloading digital data from a URL, viewing the corresponding web page and interacting with the web page without exposing the downloaded digital data to the permanent memory of the user's computer.

The present invention is also a novel method of preventing malicious code contained in emails or attachments to emails from being exposed to the permanent memory of the user's computer.

The method of the present invention comprises routing incoming digital data to a conversion device which converts the digital data into an analog signal and displays the analog signal on a viewing device capable of displaying an analog signal such as a television set or a computer monitor configured to display analog signals. Malicious code incorporated into the incoming digital data are only temporarily stored in the transient memory of the conversion device and, because the conversion device is not electronically interconnected with the permanent memory storage devices of the user's computer, the malicious code is rendered incapable of effecting operations on the permanent memory devices or other components of the computer, including writing themselves to the hard drive or other permanent memory storage devices of the user's computer.

The user views the analog signal output on the television or monitor screen and can interact with the displayed web page or email through input devices such as a keyboard, mouse, infrared remote control or other common input devices. Any of the commonly available computer input devices may be used. The browser application of the conversion device receives input data or signals from the input device, performs the appropriate task or action associated with the input received, and generates the appropriate digital display signal incorporating the results of that action, which signal is then converted into an analog signal to be displayed.

Conversion devices similar to that contemplated for use in the present invention are known and currently exist in the marketplace, though they typically require that the user sign up for the provider's services as well. Examples of such “set top” conversion devices include Microsoft's MSN TV Service (formerly known as WebTV), AmericaOnline's AOLTV and Nokia's Mediaterminal.

The conversion device of the present invention could be either a separate set top box with connection through a modem to a network or a separate card incorporated into the user's computer with a connection to the computer's modem to allow it access to the Internet or other network.

### BRIEF DESCRIPTION OF THE DRAWINGS

The particular features and advantages of the invention as well as other objects will become apparent from the following description taken in connection with the accompanying drawings in which:

FIG. 1 illustrates a typical hardware set-up and Internet connection upon which the present method of surfing the Internet without exposing the permanent memory of the user's computer to malicious code may be practiced;

FIG. 2 schematically illustrates the inventive method of surfing the Internet without exposing the permanent memory of the user's computer to malicious code; and

FIG. 3 schematically illustrates an exemplary user interaction with the web browser application in accordance with the method of the present invention.

### DETAILED DESCRIPTION OF THE PREFERRED EMBODIMENT

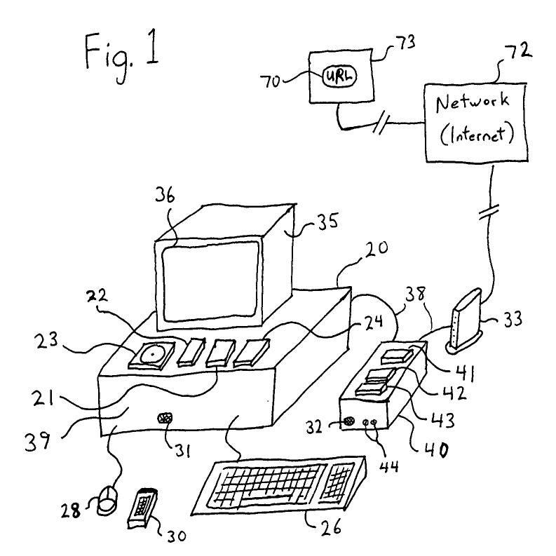

FIG. 1 shows a presently preferred exemplary embodiment of a user's computer 20 upon which the present method of accessing a URL 70 on a computer network 72 such as the Internet or another global computer network without exposing the memory 22 or 23 of the computer 20 to malicious code may be practiced. User's computer 20 may for example be a standard personal computer including a main processor unit 21, transitory memory such as random access memory (RAM) 22, permanent memory storage devices such as a hard drive 23, read only memory (ROM) 24, writable disk drives (not shown) or zip drives (not shown), at least one monitor 35, one or more input devices such as keyboard 26, mouse 28, or infrared remote control 30 (which communicates with the computer 20 via infrared sensor 31) and a modem 33 for communicating with the computer network 72.

Connected to user's computer 20, between the computer 20 and a modem 33 for communicating with the network 72, is a means for converting a digital display signal into an analog display signal. Preferably such means for converting a digital display signal into an analog display signal comprises a conversion device 40 having transient memory 41, a graphics engine 42 and an application-specific integrated circuit (ASIC) chip 43 designed for a web browser application 43. Alternatively, the conversion device 40 may also comprise an application-specific integrated circuit (ASIC) designed for an email-client application (not shown). Conversion device 40 may alternately include one or more sensors, such as infrared sensor 32, for directly receiving input signals from an infrared or other type of remote control 30 or may include one or more connections 44 for receiving cable attachments for input devices such as a mouse or keyboard.

As illustrated in FIG. 1, the conversion device 40 may be an independent unit housed outside of the computer 20 connected by one or more cables 38 appropriate for carrying the necessary signals, or the conversion device 40 may be in the form of a card (not shown) or circuit board (not shown) that may be installed within the housing 39 of the computer 40. Furthermore, the method of the present invention is scalable to allow more than one computer 20 to access the conversion device 40, either simultaneously or in series, to protect an entire group of computers (not shown) such as a network operated by a governmental entity or business.

The method of the present invention may be practiced using as the conversion device 40 any of the aforementioned commercially available “set top” boxes that allow a user to view and interact with the Internet over a standard analog television instead of a typical computer monitor 40. However, in one preferred embodiment, the conversion device 40 of the present method would not require the user to subscribe to a third party service for efficacy.

The modem 33 is a typical broadband, DSL, dial up or other modem capable of transmitting and receiving data from the Internet or other computer network 72. While FIG. 1 shows the conversion device 40 connected intermediate the modem 33 and the computer 20, it is known in the art how to configure modem 33 connections or signal routing to connect directly or indirectly to the computer 20 as desired.

In order to practice the inventive method, monitor 35 must be a display device capable of displaying an analog signal. Monitor 35 may be either a typical television (not shown) of any type commercially available to the consuming public or a computer monitor 35 adapted to receive and display an analog signal in addition to a digital display signal. Depending on the type of monitor 35 utilized, the user may be required to toggle or switch the monitor 35 between a first condition for displaying digital signals and a second condition for displaying analog signals. Alternatively, a monitor 35 may be used that is adapted to distinguish between incoming analog and digital signals and switch between such first and second display conditions based on the type of signal received and/or the user's mode of operation of either the computer 20 or the conversion device 40. For example, even if the user had the browser application 43 of the conversion device 40 running, if the user were primarily utilizing a software application running on the computer 20 and not the conversion device 40, it would be a simple task for one skilled in the art to create a means for detecting that the user's primary mode of operation was a program on the computer 20 and so configure the monitor to display the digital signals received from the computer 20 rather than the analog signals received from the conversion device 40.

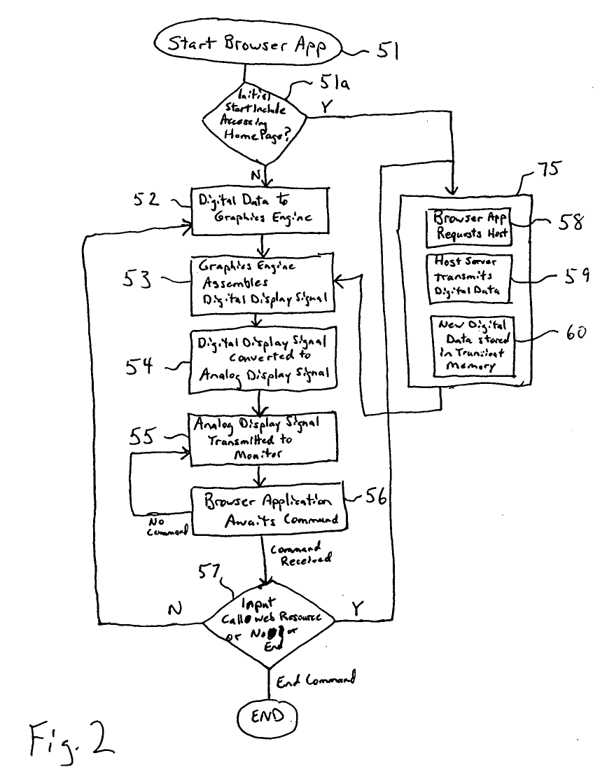

Turning then to FIG. 2, a flow chart of a preferred method of the present invention utilizing the hardware configuration of FIG. 1 is shown. The method begins at step 51 with the user commanding activating the browser application 43 of the conversion device 40 directly or indirectly using the computer 20 to access the browser application 43 of the conversion device 40. Alternately, the browser application 43 of the conversion device 40 may open automatically upon start-up of the computer 20.

The browser application 43 may be configured to allow the user to select whether or not the secure mode of the present invention will be used for web browsing, or, alternately, may be configured to default to the secure mode while allowing the user to select a non-secure mode of browsing as needed, for instance, if a program, email attachment, or other file needs to be downloaded to the permanent memory 23, 24 of the computer 20. The presently preferred browser application 43 is configured to automatically default to the secure mode of the present method as it would otherwise be redundant of existing capabilities of the computer 20. However, it is to be understood that the opposite, non-secure default mode is equally within the contemplation of the present invention as well as the user's ability to switch between secure and non-secure modes of browsing at any time during the browsing process.

In secure mode, the browser application 43, graphics engine 42 and any other additional features of the conversion device 40 requiring the use of memory (such as the alternative ASIC email-client application) are configured to utilize only the transient memory 41 of the conversion device 40. As explained in additional detail below, it is this segregation of digital data while interacting with the Internet that is a novel feature of the present method. As is known in the art, most computer processes require the constant storing and retrieval of data in computer memory. It will be understood by those skilled in the art that each of the steps of the method described herein similarly require data to be stored and retrieved, however, when practicing the method of the present invention only the transient memory 41 of the conversion device 40 is used for this purpose, thereby avoiding the transmittal of digital data to other memory 22, 23, 24 of the computer 20. The conversion device 40 is not electronically connected to the computer 20 in such a manner as to allow downloaded digital data to gain access to or be stored on the permanent memory storage devices of the computer 20 without the express authorization of the user.

After the initial start-up (step 51), in step 52 the browser application 43 generates and sends an initial instruction (digital data) to the graphics engine 42 of the conversion device 40, which initial instruction, when processed by the graphics engine 42 in step 53, results in the assembly of an initial digital display signal corresponding to the start screen view to be output on the screen 36 of the monitor 35 for the user's viewing as her graphical user interface for the browser application 43. As is typical, the browser application 43 may be configured as desired by the user to automatically access and display an initial web page, known as a home page, upon start-up. If so configured, then after the start-up step 51, a decision step 51a prior to step 52, would call the download routine 75 comprising steps 58 through 60 which describe the method of accessing, downloading and securely viewing a web based resource 70. However, for ease of illustration and description only, in FIG. 2, after the start-up step 51, the following description assumes that the initial digital display signal generated by steps 52 and 53 will merely comprise a screen view of the browser application's 43 graphical user interface (not shown).

After a digital display signal is assembled by the graphics engine 42, in step 54 the conversion device 40 converts the digital display signal into an analog display signal format that may be understood and displayed by a television (not shown) or monitor 35, which, as discussed above, is capable of displaying analog display signals. In North America, the National Television Standards Committee (NTSC) is the specification that defines video and audio formats for television. The use of alternate specified analog television formats utilized in other geographic locations are expressly within the contemplation of this invention.

In step 55, the analog display signal is then transmitted to the monitor 35 where it may be viewed by the user. As noted above, the monitor 35 may be configured to readily accept and display analog display signals, or may be configured to allow the user to select the type of display signals the monitor 35 will show. Alternatively, the initial opening of the browser application 43 of the conversion device 40 may include setting the monitor 35 to receive and display analog signals.

Once the analog display signal has been displayed, it continues to be displayed while the browser application awaits further commands in step 56. If no command is received, the prior analog display signal is continued to be displayed.

When an input is received, in step 57 the browser application 43 determines whether an Internet-based resource 70 must be accessed or whether the input is merely an interaction not requiring the browser application 43 to access another resource 70, such as if the mouse were moved or a letter typed. If the input requires an Internet-based resource 70 to be accessed, the download routine 75 is called, otherwise the browser application 43 alone can generate new digital data corresponding to the input received and thus return the method to step 52.

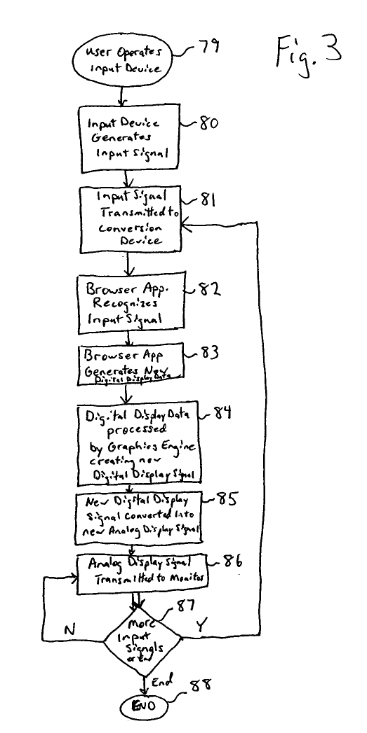

Assuming an Internet- or web-based resource 70 is called, the method of the present invention continues in step 57 wherein the user has interacted with the browser application 43 as desired by using one or more input devices such as (but not limited to) keyboard 26, mouse 28, or infrared remote control 30 to convey a command to the browser application 43 of the conversion device 40 requiring the accessing of a URL 70. The routine (steps 79 through 88) describing a user's interaction with the browser application 43 of the conversion device 40 is described in greater detail in the discussion relating to FIG. 3.

As shown in step 58 of FIG. 2, the user has commanded the browser application 43 to access a particular website or URL. Upon receipt of such command, the browser application 43 utilizes the modem 33 to send a request to the networked server 73 hosting the desired URL 70.

In step 59, in response to the inquiry from the browser application 43, the server 73 hosting the requested URL 70 transmits the digital data containing the information necessary to construct the web page. In reality, this step is a series of well-understood communications through the modem 33 between the browser application 43 and the hosting server 73 or other servers hosting the resources that are required to assemble all of the files, graphics, text, resources and other digital data that comprise the desired web page. As the downloaded digital data is received, in step 60 the digital data is stored in the electronic transient memory 41 of the conversion device 40.

After receipt of the new digital data, the method returns to step 53 wherein the graphics engine 42 of the conversion device 40 then assembles a digital display signal corresponding to the web site view from the downloaded digital data, and, between steps 53 and 54, stores it in the transient memory of the conversion device 40.

Upon receipt of a new digital display signal, in step 54, the conversion device 40 converts the new digital display signal into a new analog display signal. In step 55, the conversion device 40 then sends the new analog display signal to the monitor 35 where it may be viewed by the user.

After the downloaded digital data is converted by the graphics engine 42 into a new digital display signal, all or a portion of the downloaded digital data may be cleared from the transient memory 41 of the conversion device 40. For example, a portion of the downloaded digital data would only be retained in the transient memory 41, if that data were necessary for generating a visual element of the web site being displayed that changed over time, such as a video clip or slideshow element. When it is no longer necessary, the downloaded digital data is erased from the transient memory of the conversion device 40.

While practicing the present method, digital data that is downloaded from the web site 70, including any malicious code, is never loaded into either the transient memory 22 or the permanent memory 23, 24 of the computer 20. The downloaded digital data received from web site 70 is stored only in the transient memory 41 of the conversion device 40 and is eventually cleared from the transient memory 41. By segregating the downloaded digital data in the conversion device 40 away from the other components of the computer, malicious code that may be downloaded with or as part of the downloaded digital data gains access only to the transient memory 41 of the conversion device 40 where it is unable to be permanently stored or to execute or have any other effect on other components of the computer 20.

FIG. 3 is a flow chart of an example user interaction with the browser application 43 of a displayed web site in accordance with the method of the present invention. For exemplary purposes, the discussion will describe a user viewing a web page 70, using a mouse 28 to move the pointer to a link to another web page or URL, then clicking on the link. However, the steps illustrated will be followed regardless of the type of input received or input device utilized.

The flow chart begins at step 79 with the user viewing a displayed web page 70 and operating an input device, such as mouse 28, which, as shown in step 80, generates a digital input signal. In this case, the movement of the mouse 28 creates digital input signals in a manner familiar in the art.

In step 81, the digital input signal is relayed either directly to the conversion device 40, or indirectly through the computer 20 to the conversion device 40 where it is received by the browser application 43 of the conversion device 40.

In step 82, the browser application 43 recognizes the input signal as being associated with a certain action, in this example, the movement of the pointer across the screen 36 of the monitor 35.

In step 83, the browser application 43 generates new digital display data reflecting the action associated with the input signal, in this case, an increment of movement of the pointer across the display screen 36.

In step 84, the new digital display data is processed by the graphics engine 42 of the conversion device 40 and assembled into a new digital display signal reflecting the moved pointer relative to the prior web page view.

In step 85, the new digital display signal is converted by the conversion device 40 into a new analog display signal and, in step 86 the new analog display signal is transmitted to the monitor 35 for viewing by the user.

In step 87, a decision is made whether additional input has been received, such as the next increment of movement of the mouse 28 or the click of the mouse 28 on the link. If additional input signals are received, the process of steps 81 through 87 continues until no further input is received from the user, at which time the last analog display signal will continue to be displayed until the user resumes interaction with the browser application 43 or turns off the browser application 43 in end step 88.

It should be understood that the commands transmitted to the browser application 43 by the user through the input devices 26, 28 and 30 and resulting input signals could include directing the browser application 43 to access additional web sites, resources or URL's 70 on the network 72. Such commands would begin again the method of securely downloading digital data described above.

Even when operating in secure mode, the browser application 43 of the conversion device 40 will preferably allow the user the option of downloading a specific resource 70 (such as a program, document, email, picture, music file, video vile or other types of files) to a permanent memory device 23 of the computer 20, such as if the user wanted to retain a copy for later use. Obviously such action will risk the downloaded resource 70 infecting the computer 20 with some type of malicious hidden code, but utilizing the method of securely surfing the internet of the present invention will avoid the unintentional infection of malicious code. Other types of software exist which the user may employ to screen resources prior to downloading if the user selects a non-secure mode of operation.

The method of the present invention is also useful in preventing malicious code of the types frequently transmitted by emails or attachments to emails from being downloaded into the permanent memory storage devices of a computer. Those skilled in the art will recognize that this may be accomplished in a number of ways, the two most preferred methods comprising either the use of an ASIC email client application built into the conversion device, or the utilization of a web based email client which the user accesses using the browser application in the same manner as any other web site.

Numerous alterations of the method herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A method of surfing the internet without exposing a permanent memory storage: device of a user's computer to downloaded data, said method comprising the steps of:
(a) routing digital data returned from an accessed URL to a conversion device, said conversion device not having an electronic connection to any permanent memory storage device of the computer;
(b) reassembling a digital display signal from the digital data using a graphics engine of the conversion device;
(c) converting the digital display signal into an analog display signal; and
(d) displaying said analog display signal on an analog display device.

2. The method of claim 1 further comprising the step of storing the digital data in transient memory of the conversion device.

3. The method of claim 1 further comprising the step of storing the digital display signal in transient memory of said conversion device.

4. The method of claim 1 further comprising the step of clearing the digital data from the transient memory of the conversion device.

5. The method of claim 1 further comprising the step of clearing the digital display signal from the transient memory of the conversion device.

6. The method of claim 1 further comprising the steps of:
(a) using an input device to provide input data to the conversion device;
(b) said conversion device performing an action associated with said input data.

7. The method of claim 1 wherein the conversion device further comprises an ASIC email client application for sending and receiving emails utilizing the conversion device.

8. The method of claim 1 further comprising the step of receiving email through an email client application of the conversion device.

9. A method of interacting with a computer network comprising:
(a) accessing a URL of the network using a browser application of a conversion device connected to a computer having one or more memory storage devices, the conversion device having transient memory isolated electronically from the memory storage devices of the computer;
(b) downloading digital data from the URL to the conversion device;
(c) assembling a digital display signal from the digital data;
(d) converting the digital display signal into an analog display signal; and
(e) displaying the analog display signal on an analog display device.

10. The method of claim 9 further comprising the step of inputting commands to the browser application through one or more input devices.

11. The method of claim 9 further comprising the step of storing the digital data in the transient memory of the conversion device.

12. The method of claim 9 further comprising the step of storing the digital display signal in the transient memory of the conversion device.

13. The method of claim 9 further comprising the step of clearing the digital data from the transient memory of the conversion device.

14. The method of claim 9 further comprising the step of clearing the digital display signal from the transient memory of the conversion device.

15. The method of claim 9 wherein the conversion device further comprises an ASIC email client application for sending and receiving emails utilizing the conversion device.

16. The method of claim 9 further comprising the step of receiving email through an email client application of the conversion device.
